(19) United States
(12) Patent Application Publication
(10) Pub. No.: US 2023/0064796 A1
(43) Pub. Date: Mar. 2, 2023

(54) HYDROPONIC APPARATUS

(71) Applicant: AQUPONI INC., Yokohama-city (JP)

(72) Inventor: Ng Wee Feng, Klang Selangor (MY)

(21) Appl. No.: 17/899,932

(22) Filed: Aug. 31, 2022

(30) Foreign Application Priority Data
Aug. 31, 2021 (JP) 2021-141895

(51) Int. Cl. A01G 31/06

(52) U.S. Cl. CPC A01G 31/06

(57) ABSTRACT

A hydroponic apparatus for growing a plant using liquid is provided. The hydroponic apparatus includes a component having a plurality of holders for holding a cup on which the plant is placed. The plurality of holders are spaced from each other in a circumferential direction relative to a central line of the component. The component has a projection for retaining a root produced by the plant.

### CROSS-REFERENCE TO RELATED APPLICATION

This application claims priority to Japanese Patent Application No. JP 2021-141895 filed on Aug. 31, 2021, the contents of which are hereby incorporated by reference in its entirety.

### TECHNICAL FIELD

The present invention relates to a hydroponic apparatus for performing soilless cultivation, used in an aquaponics system. The aquaponics system includes the hydroponic apparatus for growing plants such as vegetables, and a fish and shellfish breeding apparatus for breeding aquatic animals such as fish.

### BACKGROUND

Conventionally, recirculating aquaponics has been used. The aquaponics uses a hydroponic apparatus which utilizes nutrient water (chemical fertilizer or organic fertilizer) necessary for the growth of products as liquid fertilizer, and uses a fish and shellfish breeding apparatus for breeding aquatic animals such as fish in combination, and circulates water for breeding fish between the hydroponic apparatus and the fish and shellfish breeding apparatus.

Japanese Laid-Open Patent Publication No. 2017-139980 discloses an aquaponics system using aquaponics. The conventional aquaponics system has structure where cultivation beds in a plurality of stages for cultivating a plant are disposed on a rearing tank for breeding fish, and bell siphons are provided on the cultivation beds, respectively. The bell siphons discharge liquid at more than twice the rate and momentum at which the liquid is supplied. As a result, clogging of a discharge pipe and adhesion of foreign objects to the discharge pipe are prevented. By discharging the liquid all at once from the discharge pipe coupled to the plurality of bell siphons, it is possible to supply sufficient oxygen to the liquid stored in the rearing tank.

In the aquaponics system disclosed in Japanese Laid-Open Patent Publication No. 2017-139980, the plurality of cultivation beds are disposed in a vertical direction, and the liquid is supplied to each of the cultivation beds through a water supply pipe by a water supply pump. Further, the liquid discharged from each of the cultivation beds is supplied to the rearing tank through the discharge pipe. As described above, in the aquaponics system disclosed in Japanese Laid-Open Patent Publication No. 2017-139980, since it is necessary to provide the pump and the bell siphons for supplying the liquid from each of the cultivation beds to the rearing tank, it is difficult to achieve the compact structure of the cultivation beds, and as a result, it is difficult to reduce the time required for installation and maintenance of the aquaponics system, and reduce the cost required for installation and maintenance of the aquaponics system.

Further, the cultivation bed of the aquaponics system disclosed in Japanese Laid-Open Patent Publication No. 2017-139980 has a rectangular shape in a plan view. Therefore, in order to increase the storage capacity of the cultivation bed for storing the plant, it is necessary to increase the area of the cultivation bed in a horizontal direction. Under the circumstances, it is difficult to increase the storage capacity of the cultivation bed depending on the place where the aquaponics system is installed.

### SUMMARY

The present invention has been made taking the above circumstances into account. That is, an object of the present invention is to provide a hydroponic apparatus in which it is possible to simplify the hydroponic apparatus, reduce the time and the cost required for installation operation and maintenance of the hydroponic apparatus, and increase the storage capacity.

In order to solve the above problems, and achieve the above object, in the present invention, a hydroponic apparatus for growing a plant using liquid is provided. The hydroponic apparatus includes a component having a plurality of holders for holding a cup on which the plant is placed. The plurality of holders are spaced from each other in a circumferential direction relative to a central line of the component. The component has a projection for retaining a root produced by the plant.

In the specification, while the hydroponic apparatus has simple structure, the “hydroponic apparatus” means an apparatus for performing soilless cultivation which uses nutrient water as a chemical fertilizer necessary for the growth of plant, and a soilless cultivation apparatus for performing organic cultivation using animal and plant fertilizers such as manure from livestock pens, bonito broth, plant soaking liquid, and weed liquid instead of chemical fertilizers. Further, the “products” means plants such as vegetables, fruits, fruit trees, and flowers, and aquatic animals such as fish and shellfish, regardless of whether or not chemical fertilizers are used. In the specification, the “seeds” means seeds of plants such as vegetables, fruits, fruit trees, and flowers.

In the hydroponic apparatus according to the present invention, since a channel associated with a plurality of plant containers where the plants are placed is shared, it is possible to simplify the hydroponic apparatus and the cup, reduce the time required for installation operation and maintenance of the hydroponic apparatus, reduce the cost required for installation of the hydroponic apparatus, and increase the storage capacity for storing the plants.

### BRIEF DESCRIPTION OF THE DRAWINGS

FIG. 1 is a schematic view showing a hydroponic apparatus according to a first embodiment of the present invention.

FIG. 2A is a perspective plan view showing a first component of the hydroponic apparatus according to the first embodiment of the present invention; and

FIG. 2B is a perspective rear view showing the first component of the hydroponic apparatus according to the first embodiment of the present invention.

FIG. 3A is a perspective plan view showing a second component of the hydroponic apparatus according to the first embodiment of the present invention; and

FIG. 3B is a perspective rear view showing the second component of the hydroponic apparatus according to the first embodiment of the present invention.

FIG. 4A is a perspective plan view showing a third component of the hydroponic apparatus according to the first embodiment of the present invention; and

FIG. 4B is a perspective rear view showing the third component of the hydroponic apparatus according to the first embodiment of the present invention.

FIG. 5 is a schematic perspective view showing a hydroponic apparatus according to a second embodiment of the present invention.

FIG. 6A is a schematic view mainly showing a first component, a second component, and a third component of the hydroponic apparatus according to the second embodiment of the present invention; and

FIG. 6B is a plan view showing the second component of the hydroponic apparatus according to the second embodiment of the present invention; and

FIG. 6C is a cross sectional view along a line VI-VI in FIG. 6B.

FIG. 7A is a plan view showing a third component of the hydroponic apparatus according to second embodiment of the present invention; and

FIG. 7B is a rear view showing the third component of the hydroponic apparatus according to the second embodiment of the present invention.

FIG. 8A is a plan view showing a cup according to the embodiment of the present invention;

FIG. 8B is a plan view showing a cup body of the cup according to the embodiment of the present invention;

FIG. 8C is a perspective rear view showing the cup according to the embodiment of the present invention; and

FIG. 8D is a side view showing the cup body according to the embodiment of the present invention;

FIG. 9A is a plan view showing a fourth component of the hydroponic apparatus according to the first embodiment of the present invention; and

FIG. 9B is a front view showing the fourth component of the hydroponic apparatus according to the first embodiment of the present invention.

### DETAILED DESCRIPTION

Hereinafter, embodiments of a hydroponic apparatus according to the present invention will be described with reference to the drawings. In the following description, the components having the same structure will be labelled with the same reference numerals, and description thereof will be omitted or simplified.

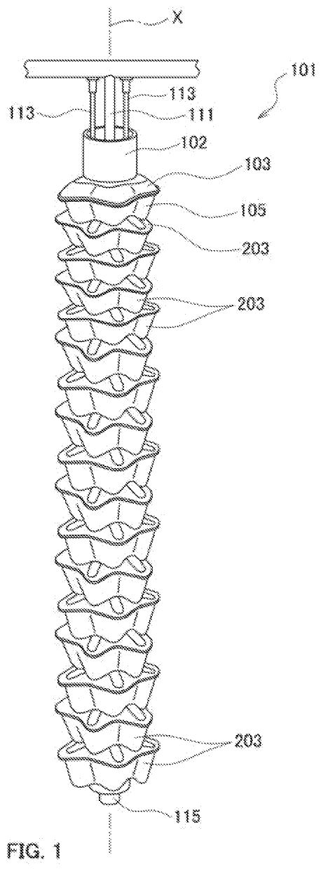

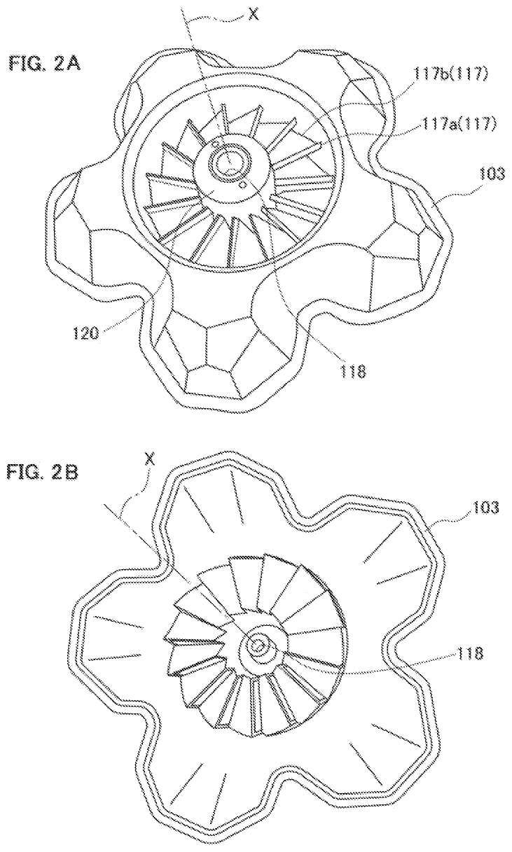

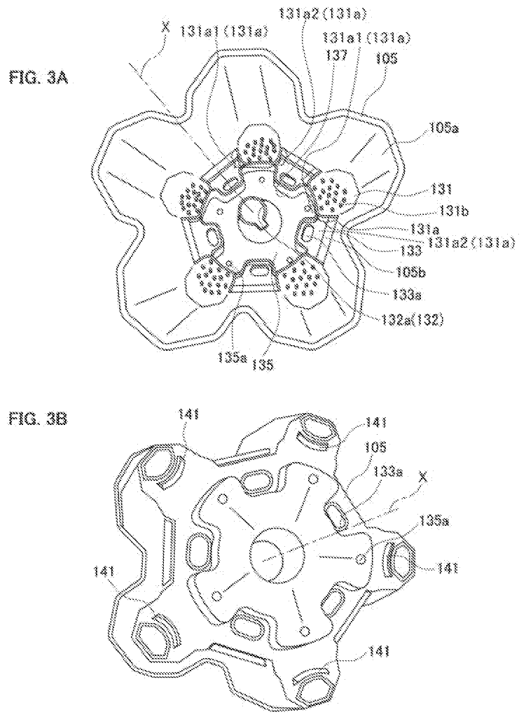

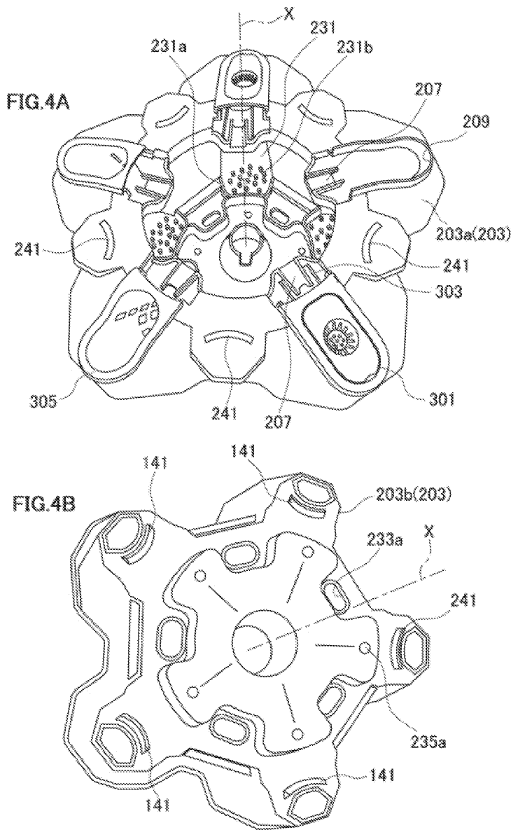

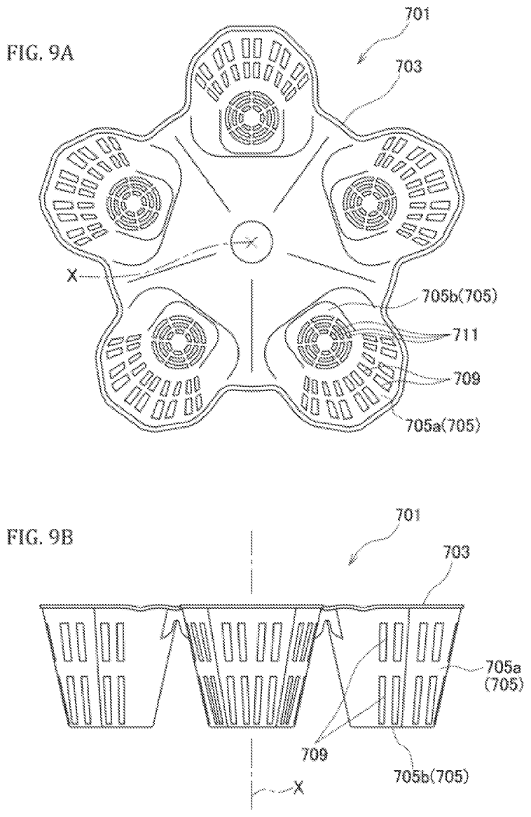

FIG. 1 is a schematic perspective view showing a hydroponic apparatus 101 according to a first embodiment of the present invention, FIG. 2A is a perspective plan view showing a first component 103 of the hydroponic apparatus 101 according to the first embodiment of the present invention, FIG. 2B is a perspective rear view showing the first component 103 of the hydroponic apparatus 101 according to the first embodiment of the present invention, FIG. 3A is a perspective plan view showing a second component 105 of the hydroponic apparatus 101 according to the first embodiment of the present invention, FIG. 3B is a perspective rear view showing the second component 105 of the hydroponic apparatus 101 according to the first embodiment of the present invention, FIG. 4A is a perspective plan view showing a third component 203 of the hydroponic apparatus 101 according to the first embodiment of the present invention, FIG. 4B is a perspective rear view showing the third component 203 of the hydroponic apparatus 101 according to the first embodiment of the present invention, FIG. 9A is a plan view showing a fourth component 701 of the hydroponic apparatus 101 according to the first embodiment of the present invention, and FIG. 9B is a front view showing the fourth component 701 of the hydroponic apparatus 101 according to the first embodiment of the present invention.

The embodiment is the hydroponic apparatus 101 for breeding plants such as vegetables by soilless cultivation. The hydroponic apparatus 101 is fixed to a rotation shaft 111 extending in a vertical direction, i.e., in a direction of a rotation axis (imaginary central line) X. It is a matter of course that the rotation shaft 111 is rotatably supported. Further, reference numerals 113 denote liquid supply pipes. In the embodiment, two liquid supply pipes 113 are provided to form a liquid channel from a liquid source (not shown). Further, the hydroponic apparatus 101 includes a cylindrical cover member 102 at the uppermost level, and the cover member 102 is attached to the first component 103 described later. Further, the hydroponic apparatus 101 includes a bottom member 115 at the lowermost level. The bottom member 115 can prevent the liquid supplied into the hydroponic apparatus 101, from being discharged to the outside of the hydroponic apparatus 101 unexpectedly.

The first component 103 and the second component 105 have shapes that are complementary to each other. When the first component 103 is attached to the second component 105, an internal space defined by the first component 103 and the second component 105 is closed substantially. The first component 103 includes five protruding areas disposed at equal intervals in a circumferential direction relative to the rotation line X. The five protruding areas have the same shape. Moreover, in the plan view, a through hole 118 attached to the rotation shaft 111 is provided at the center of a central portion 120 of the first component 103.

A plurality of feather members 117 are provided coaxially with the central portion 120. The feather members 117 have the same shape. Each of the feather members 117 has a base portion 117a extending in the direction of the rotation axis X, and an inclined portion 117b extending in a direction inclined from the base portion 117a. In the structure, a rotational force which rotates the hydroponic apparatus 101 clockwise is generated by a force of the liquid dropping from the liquid supply pipe 113 applied to the inclined portions 117b.

It should be noted that, as long as the shape and the number of the feather members 117 are configured to generate the rotational force by supply of the liquid, the shape and the number of the feather members 117 can be changed as necessary. Further, while the embodiment of the present invention adopts structure where the hydroponic apparatus 101 and the rotation shaft 111 rotate together, it may be possible to adopt structure where the rotational shaft 111 is fixed, and the hydroponic apparatus 101 rotates about the fixed shaft. Further, although the embodiment of the present invention adopts hydraulic drive structure where the feather members 117 are rotated by the liquid, the present invention is not limited to the structure. The present invention may adopt structure where an electric motor which is operated by electricity is utilized to enable rotation instead of the feather members. In the case where the electric motor is employed, the hydroponic apparatus 101 and the rotation shaft 111 rotate together.

As shown in FIG. 3A, the second component 105 is attached to the first component 103. In the plan view of the second component 105, a protrusion 132 having a through hole 132a is provided at the center of the second component 105. The protrusion 132 is disposed on a first surface 135 of the second component 105. A plurality of through holes 135a are provided at equal intervals in a circumferential direction relative to the rotation axis X in the first surface 135, for discharging the liquid through the through holes 135a. Further, the second component 105 has a second surface 133, and the second surface 133 is disposed at a position lower than the first surface 135 in the vertical direction. The second surface 133 has through holes 133a each having a substantially oval shape in the plan view. The through holes 133a pass through the second surface 133 in the direction of the rotation axis X. Further, the second component 105 has a third surface 131, and the third surface 131 is disposed at substantially the same height as the second surface 133 in the vertical direction. The second surface 132 has a through hole 133a having a substantially oval shape in the plan view. The through hole 135a passes through the third surface 131 in the direction of the rotation line X. The second surface 133 and the third surface 131 are separated from each other by a wall 131a defining the third surface 131.

The third surface 131, an inner surface 105a of the second component 105, and the wall 131a form a region which retains the liquid. Further, projections 131b protruding in parallel with the rotation axis X are provided on the third surface 131. When plant roots are entangled with the projections 131b, the roots are retained on, or around the third surface 131. Therefore, it is possible to prevent clogging of the liquid channel.

It should be noted that the plurality of projections 131b according to the embodiment are dimensioned such that as the projections 131b are located closer to the rotation axis X, the length of the projections 131b is longer in a longitudinal direction. Further, the length of the projections 131b in the direction parallel to the rotation axis X are dimensioned such that as the projections 131b are located farther from the rotation axis X, the projections 131b are shorter. It should be noted that the second surface 133 is defined by a step 105b and a wall 137.

The wall 131a each has a longer portion 131a1 and a shorter portion 131a2. The longer portion 131a1 is longer than the shorter portion 131a2 in respect to the direction parallel to the rotation axis X. In the structure, when the amount of the liquid flowing toward the third surface 131 reaches an amount that exceeds the shorter portion 131a2 of the wall 131a, the liquid goes over the shorter portion 131a2 of the wall 131a, and reaches the second surface 133. Further, when the amount of the liquid flowing toward the third surface 131 reaches an amount that exceeds the longer portion 131a1 of the wall 131a, the liquid reaches the second surface 133 or the first surface 135.

As shown in FIG. 3B, on the back surface of the second component 105 (at each position corresponding to the third surface 131), a fixed projection 141 having a U-shape in the rear view is provided. The fixed projection 141 projects in a direction parallel to the rotation axis X.

The third component 203 will be described with reference to FIGS. 4A and 4B. It should be noted that the third component 203 includes a lid 203a shown in FIG. 4A and a container 203b shown in FIG. 4B. In the embodiment, though the lid 203a and the container 203b have detachable structure, the lid 203a and the container 203b may comprise one piece component part. Further, the container 203b and the second component 105 shown in FIGS. 3A and 3B have the same shape and the same dimensions. Therefore, part of the container 203b which is not specifically noted is the same as the second component 105.

The lid 203a is disposed in a manner to close an opening of the container 203b having a flower shape (see FIG. 3A). The lid 203a has cup holders 209 for holding cups 301 described later, at each position corresponding to the third surface 131. A lid channel 207 is provided at a position of the cup holder 209 close to the rotation axis X, for supplying the liquid supplied from the second component 105, to the cup 301. In the state where the cup 301 is attached to the cup holder 209, in the plan view, the lid channel 207 is disposed above the cup channel 303 of the cup 301.

Further, a recess 241 as a depression having a shape and dimensions complementary to the fixed projection 141 shown in FIG. 3B is provided, between the adjacent cup holders 209 of the lid 203a. Therefore, the fixed projection 141 of the second component 105 is fitted to the lid 203a of the third component 203, and the second component 105 and the third component 203 are fixed together.

Next, a fourth component 701 will be described with reference to FIGS. 9A and 9B. The fourth component 701 functions as a net for trapping foreign objects such as root tips and fish droppings which may be contained in the liquid circulated, and used in the aquaponics system. By the fourth component 701, it is possible to prevent clogging of the liquid channel due to the foreign objects. The fourth component 701 has a shape complementary to the second component 105 shown in FIG. 3A, and has a shape which is attached to the second component 105.

The fourth component 701 has a base portion 705 and an upper end portion 703 defining an upper end area of the base portion 705. The base portion 705 includes a side wall 705a which is continuous with the upper end portion 703, and a bottom portion 705b which is continuous with the side wall 705a. The side wall 705a is expanded from the bottom portion 705b in a parallel direction parallel to the central line X. Further, the side wall 705a has a plurality of first through holes 709 passing through the side wall 705a in the thickness direction. The bottom portion 705b includes a plurality of second through holes 711 passing through the bottom portion 705b in the thickness direction. In the embodiment, the first through holes 709 have a rectangular shape, and the second through holes 711 have a substantially fan shape. The shapes, the dimensions, and the numbers of the first and second through holes 709, 711 can be changed as necessary. It is also possible to increase dust collection capability by placing a filtering material such as a porous material in the recess defined by the side wall 705a and bottom portion 705b.

In the state where the fourth component 701 is attached to the second component 105, since the second through holes 711 are positioned above the second component 105 in the vertical direction, each bottom portion 705b is disposed above each third surface 131, and the side walls 705a are disposed adjacent to the inner surface 105a of the second component 105. Therefore, the liquid flows onto the third surface 131 of the second component 105 through the first through holes 709 and the second through holes 711. Most of the liquid flowing from the fourth component 701 into the second component 105 reaches the third surface 131. As described above, the liquid which reaches the third surface 131 is supplied to the cup 301 attached to the third component 203 through the through holes 133a, 135a of the second component 105.

Further, in the embodiment, the fourth component 701 is disposed only on the second component 105. That is, the fourth component 701 is not disposed on the container 203b of the third component 203, but it may be possible to adopt the structure where the fourth component 701 is disposed on the container 203b which has the same structure as the second component 105.

In the embodiment, although the five cup holders 209 for holding the cups 301 are disposed at equal intervals in the circumstantial direction relative to the rotation axis X, the dimensions and the number of the cup holders 209 can be changed as necessary as long as the cup holders 209 can hold the cups 301. Further, the number of the third components 203 shown in FIG. 1 can be changed as necessary. Therefore, it is possible to change the length dimension of the rotation axis X of the hydroponic apparatus 101 and the number of the cups 301.

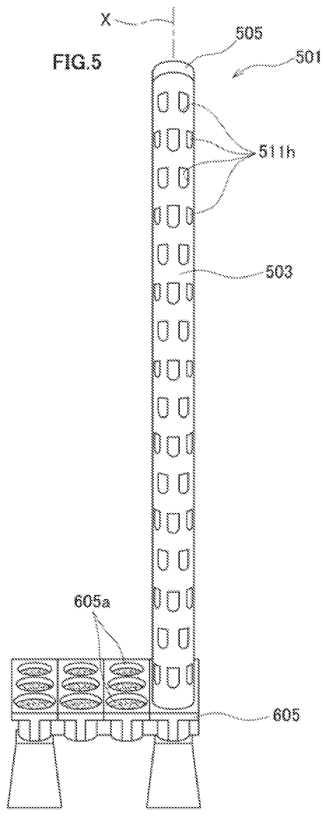

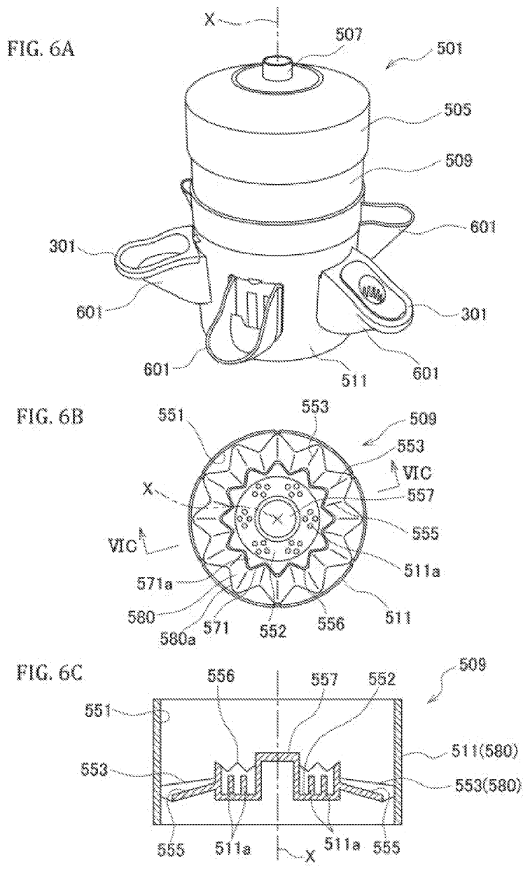

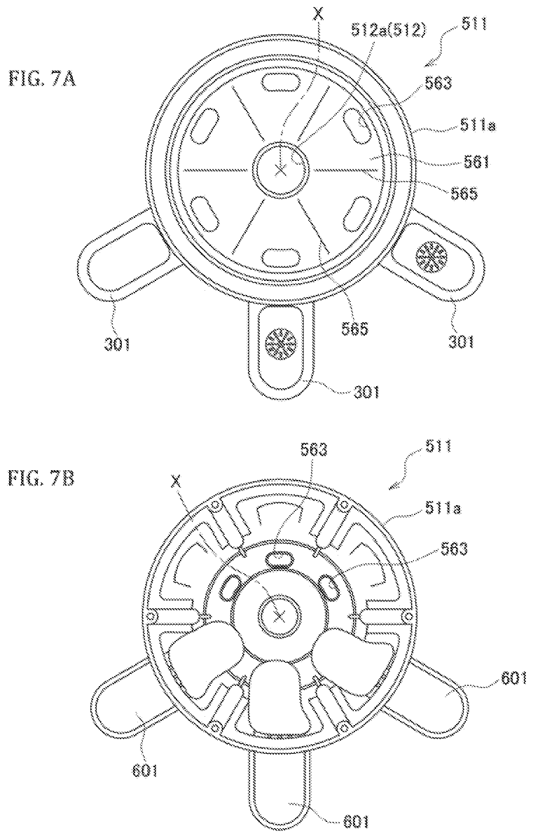

FIG. 5 is a schematic perspective view showing a hydroponic apparatus 501 according to a second embodiment of the present invention, FIG. 6A is a schematic view mainly showing a first component 505, a second component 509, and a third component 511 of the hydroponic apparatus 501 according to the second embodiment of the present invention, FIG. 6B is a plan view showing the second component 509 of the hydroponic apparatus 501 according to the second embodiment of the present invention, FIG. 6C is a cross sectional view along a line VIC-VIC in FIG. 6B showing the second component 509 of the hydroponic apparatus 501 according to the second embodiment of the present invention, FIG. 7A is a plan view showing the third component 511 of the hydroponic apparatus 501 according to second embodiment of the present invention, and FIG. 7B is a rear view showing the third component 511 of the hydroponic apparatus 501 according to the second embodiment of the present invention.

The hydroponic apparatus 501 according to the second embodiment has structure which is different from the hydroponic apparatus 101 of the rotary type according to the first embodiment in that the hydroponic apparatus 501 is fixedly attached to a base section 605. A through hole section 507 passes through a top portion of the cylindrical first component 505 (see FIG. 6A). Liquid is supplied from a liquid source (not shown) into the hydroponic apparatus 501 through the through hole section 507. It should be noted that the base section 605 has twelve storage recesses 605a, and one hydroponic apparatus 501 is disposed in one of the storage recesses 605a. In the storage recesses 605a where the hydroponic apparatus 501 is not disposed, culture medium for growing plants is disposed.

The second component 509 is a cylindrical member. The first component 505 is attached to the second component 509 on the upper side of the central line X. As shown in FIG. 6B, the second component 509 has a circular protrusion 557 coaxially with the central line X.

A saw-teeth portion 556 having a saw-teeth shape is provided outside the protrusion 557 in a radial direction. A groove 552 is formed between the protrusion 557 and the saw-teeth portion 556. Further, the groove 552 is provided with projections 511a. The projections 511a protrude from the groove 552.

The projections 511a can trap foreign objects such as root tips and fish droppings which may be contained in the liquid. By providing the projections 511a, it is possible to prevent clogging of the liquid channel due to the foreign objects. In the embodiment, in the length in parallel to the central line X, the protrusion 557 is dimensioned to be longer than the saw-teeth portion 556, and the saw-teeth portion 556 is dimensioned to be longer than the projections 511a. In the plan view of FIG. 6B, for ease of understanding the shape, the saw-teeth portion 556 is drawn to have a wavy shape in the radial direction. However, in the embodiment, the saw-teeth portion 556 has a wavy shape in a direction perpendicular to the paper surface, and has a circular shape in the plan view.

A marginal portion 580 is provided outside the saw-teeth portion 556 outside in a radial direction. The marginal portion 580 is inclined downward (in a direction parallel to the central line X) in a direction away from the central line X. It should be noted that, in the plan view, an outer surface 580a as a terminal end of the marginal portion 580 has a substantially star shape, and the outer surface 580a is coupled to an inner surface 551 of the second component 509, at substantially corners of the outer surface 580a. Therefore, the liquid flows through a gap between the outer surface 580a of the marginal portion 580 and the inner surface 151 toward a position below the marginal portion 580. The second component 509 includes the protrusion 557 to which the liquid is supplied from the outside of the hydroponic apparatus 501, the saw-teeth portion 556 which is disposed around the protrusion 557, and the marginal portion 580 which is disposed around the saw-teeth portion 556. The second component 509 has a tubular shape where the gap is defined by the outer surface 580a of the marginal portion 580 and the inner surface 551 of the second component 509.

Further, the marginal portion 580 includes protrusions 553 and recesses 555 which are alternately in the circumferential direction relative to the central line X. Further, while the embodiment has structure where the protrusions 553 are coupled to the inner surface 551, it is possible to adopt structure where the recesses 555 are coupled to the inner surface 551. Further, the marginal portion 580 is inclined downward (downward in a direction parallel to the central line X) in a direction closer to the inner surface 551. Therefore, the liquid which passes through the top part of the saw-teeth portion 556 moves toward the outer surface 580a of the marginal portion 580.

The third component 511 shown in FIGS. 7A and 7B is coupled to the second component 509. In the plan view of the cylindrical third component 511, a tubular projection 512 which defines a through hole 512a passing through the center of the third component 511 in the direction of the central line X is provided. A plurality of ridges 565 are provided at equal intervals in the circumferential direction. The ridges 565 protrude from the tubular projection 512. The ridges 565 extend substantially in a horizontal direction. Further, curved sections 561 are provided between the ridges 565. The curved sections 561 extend downward, in a direction away from the central line X, outward in the radial direction, and are in the form of recesses extending in the circumferential direction. Through holes 563 pass through the curved sections 561.

In the third component 511 having the above structure, the liquid flowing downward from the gap between the inner surface 551 of the second component 509 and the outer surface 580a flows into the inner space of the third component 511 through the through holes 563 or the through hole 512a.

Further, attachment holes 511h (see FIG. 5) pass through the outer surface 503 of the third component 511, for attaching the six cups 301 and the cup holder 601 to the third component 511. It should be noted that, for ease of understanding the structure of the third component 511 clearly, the third component 511 having only three cups 301 and the cup holders 601 is drawn in FIGS. 7A and 7B.

Although the hydroponic apparatus 501 according to the second embodiment has attachment holes 511h up to positions adjacent to the base section 605, the present invention is not limited in this respect. It is a matter of course that the position of the third component 511 having the attachment holes 511h in the height direction (position in the direction of the central line X) can be changed as necessary.

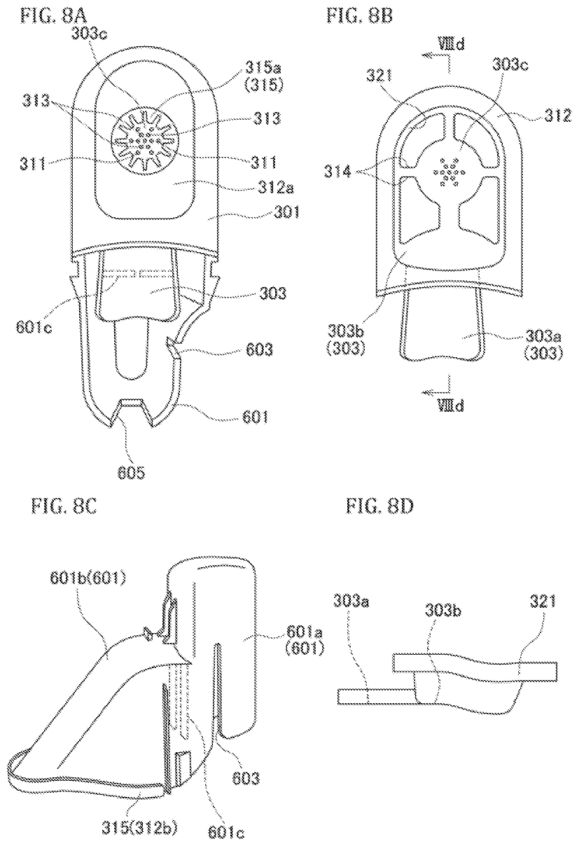

The cup 301 and the cup holder 601 which are attachably employed in the first and second embodiments will be described with reference to FIG. 8. FIGS. 8A to C show the cup 301 and the cup holder 601. The cup 301 is a storage for holding seeds of plants. The cup holder 601 is a jig configured to store the cup 301, and attach the cup 301 to the third component 511.

The cup 301 includes a cup cover 312a (see FIG. 8A) and a cup body 312b (see FIGS. 8A and 8B). The cup body 312b includes a recess 321 to which the cup cover 312a is attached, and a placement area 303c in the form of a substantially circular thin plate is provided at the center of the recess 321 for placing seeds on the placement area 303c. The placement area 303c is provided with through holes 313 which pass through the placement area 303c in the thickness direction (direction perpendicular to the paper surface of FIG. 8B), and a plurality of projections 311 provided adjacent to the outer marginal portion of the placement area 303c, and protruding upward in the vertical direction from the placement area 303c.

Further, the cup body 312b includes a first channel 303a in the form of a recess as a passage of the liquid, and a flat second channel 303b which is continuous with the first channel 303a. The outer marginal portion of the cup body 312b is flexible, and by expanding the outer marginal portion of the cup body 312b, the cup body 312b is attached to the cup holder 601.

In the embodiment, in the length of the projection 311 in the longitudinal direction, the length of the projections 311 disposed adjacent to the second channel 303b among the plurality of projections 311 is smaller than the length of the other projections 311. In the structure, it is possible to prevent liquid from being blocked by the projections 311 disposed adjacent to the second channel 303b so as to pass through the same projections 311. It is possible to trap foreign objects such as root tips and fish droppings which may be contained in the liquid, and prevent clogging of the liquid channel by the foreign objects. It is a matter of course that the diameter of the through holes 313 is dimensioned to be smaller than the diameter of the seeds which are placed on the placement area 303c.

Further, in the plan view, an opening section 315 is formed at the center of the cup cover 312a. Further, the opening section 315 includes a plurality of projections 315a extending downward in the vertical direction of the paper surface (downward in the direction perpendicular to the paper surface of FIG. 8A), and the diameter of the opening defined by the projections 315a is reduced gradually. The projections 315a are used to hold sprouts grown from the seeds.

The cup holder 601 is a cylindrical member having a bottom, and can store liquid. The cup holder 601 includes a first storage 601a, a second storage 601b, and protrusions 601c as partitions dividing inner spaces of the first and second storages 601a, 601b. The protrusions 601c are configured to allow fluid communication between the first storage 601a and the second storage 601b. The cup holder 601 is configured to be attachable to the attachment hole 511h of the third component 511 in the state where the cup 301 is attached to the cup holder 601. The protrusions 601 function to retain the plant roots inside the second storage 601b, and functions to allow the liquid to flow between the first storage 601a and the second storage 601b.

Although items, elements or components of the invention may be described or claimed in the singular, the plural is contemplated to be within the scope thereof unless limitation to the singular is explicitly stated. While the embodiments of the present invention have been described above, the present invention is not limited to these embodiments. It should be noted that various modifications and changes can be made within the gist of the present invention. This application claims the benefit of Japanese Patent Application No. 2021-141895, filed Aug. 31, 2020, which is hereby incorporated by reference herein in its entirety.

What is claimed is:

1. A hydroponic apparatus for growing plant using liquid, the hydroponic apparatus comprising:
a second component being tubular and including a protrusion to which the liquid is supplied from the outside of the hydroponic apparatus, a saw-teeth portion disposed around the protrusion, and a marginal portion disposed around the saw-teeth portion, a gap being defined by an outer surface of the marginal portion and an inner surface of the second component; and
a third component being tubular and having a plurality of holders for holding a cup where the plant is placed, the third component being coupled with the second component,
wherein the plurality of holders are spaced from each other in a circumferential direction relative to a central line of the hydroponic apparatus;
the second component includes a projection for retaining a foreign object; and
the protrusion, the saw-teeth portion and the marginal portion are arranged concentrically around the central line in an order of the protrusion, the saw-teeth portion and the marginal portion from the central line, and the liquid supplied to the protrusion is configured to flow into the third component through the saw-teeth portion, the marginal portion, and the gap.

2. The hydroponic apparatus according to claim 1, wherein the projection is provided in a groove formed between the protrusion and the saw-teeth portion.

3. The hydroponic apparatus according to claim 1, wherein the second component includes a recess configured to store the liquid, and the recess is formed between the protrusion and the saw-teeth portion, and the projection is disposed in the recess.

4. The hydroponic apparatus according to claim 1, comprising the cup,
wherein the cup includes:
a placement area where seeds are placed;
a plurality of first projections disposed around the placement area;
through holes formed around the first projections; and
a channel configured to allow the liquid to flow into the placement area,
and wherein the length of one of the first projections disposed adjacent to the channel in a longitudinal direction is shorter than the length of another of the first projections in the longitudinal direction.

5. The hydroponic apparatus according to claim 2, comprising the cup,
wherein the cup includes:
a placement area where seeds are placed;
a plurality of first projections disposed around the placement area;
through holes formed around the first projections; and
a channel configured to allow the liquid to flow into the placement area,
and wherein the length of one of the first projections disposed adjacent to the channel in a longitudinal direction is shorter than the length of another of the first projections in the longitudinal direction.

6. The hydroponic apparatus according to claim 3, comprising the cup,
wherein the cup includes:
a placement area where seeds are placed;
a plurality of first projections disposed around the placement area;
through holes formed around the first projections; and
a channel configured to allow the liquid to flow into the placement area,
and wherein the length of one of the first projections disposed adjacent to the channel in a longitudinal direction is shorter than the length of another of the first projections in the longitudinal direction.

7. The hydroponic apparatus according to claim 4, wherein a second projection configured to hold a portion produced by the seeds is disposed around the first projection in a plan view.

8. The hydroponic apparatus according to claim 5, wherein a second projection configured to hold a portion produced by the seeds is disposed around the first projection in a plan view.

9. The hydroponic apparatus according to claim 6, wherein a second projection configured to hold a portion produced by the seeds is disposed around the first projection in a plan view.
